(19) United States
(12) Patent Application Publication
(10) Pub. No.: US 2005/0210396 A1
(43) Pub. Date: Sep. 22, 2005

(54) System and method for seamlessly bringing external services into instant messaging sessions and into users' authoring environment

(76) Inventor: Marcio Dos Santos Galli, Mountain View, CA (US)

Correspondence Address: GLENN PATENT GROUP, 3475 EDISON WAY, SUITE L, MENLO PARK, CA, 94025, US

(21) Appl. No.: 11/046,327

(22) Filed: Jan. 27, 2005

Related U.S. Application Data
(63) Continuation-in-part of application No. 10/680,032, filed on Oct. 6, 2003.
(60) Provisional application No. 60/539,909, filed on Jan. 27, 2004.
(60) Provisional application No. 60/539,910, filed on Jan. 27, 2004.

(51) Int. Cl. G06F 3/00

(52) U.S. Cl. 715/758

(57) ABSTRACT

The invention provides a framework that allows a number of software application agents to be stacked on top of an instant messenger application. Each of the software application agents establishes a connection with a third-party external service on the Internet or a local application in the user's computer and enables seamless access to the external services for users of authoring applications and users engaged in instant messaging sessions.

### CROSS REFERENCE TO RELATED APPLICATIONS

This patent application is a continuation-in-part of U.S. patent application Ser. No. 10/680,032, filed on 06 Oct. 2003, and entitled “SYSTEM AND METHOD FOR SEAMLESSLY BRINGING EXTERNAL SERVICES INTO INSTANT MESSAGING SESSION.” This patent application claims priority from U.S. Provisional Patent Application Ser. No. 60/539,909, filed on 27 Jan. 2004, and entitled “METHOD AND APPARATUS FOR SEAMLESSLY BRINGING WEB CONTENT AND SERVICES INTO A USER'S IMMEDIATE AUTHORING ENVIRONMENT” and U.S. Provisional Patent Application Ser. No. 60/539,910, filed on 27 Jan. 2004, and entitled “METHOD OF SEAMLESSLY SHARING BOT-AGENTS SERVICES IN IM SESSIONS BETWEEN MULTIPLE USERS,” which are incorporated by reference herein.

### BACKGROUND OF THE INVENTION

1. Field of the Invention

This invention generally relates to Internet-based communications. More particularly, the invention relates to a system and method for seamlessly bringing third-party Web services and/or bot-agents services into online end-users' immediate authoring environment and into instant messaging sessions among the end-users.

2. Description of the Related Art

This invention aims to extend the existing messaging frameworks by external resources such as a third-party Web service or a local application into an instant messaging environment using intermediary applications.

Traditionally, a messaging system includes a messaging application programming interface (MAPI) which refers to a messaging architecture and a client interface component for applications such as e-mail, scheduling, calendaring and document management.

As a messaging architecture, MAPI provides a consistent interface for multiple application programs to interact with multiple messaging systems across a variety of hardware platforms.

MAPI supports various client applications that demonstrate different levels of messaging support, e.g. formatting text for a single message with a variety of fonts and present to users a customized view of messages that have been filtered, sorted or preprocessed.

One example of the messaging systems is NetMeeting developed by Microsoft which enables users to communicate in numerous ways such as chatting, telephoning, sharing a whiteboard for drawing, and sharing an application program. The program sharing feature allows meeting participants to view and work on files simultaneously. For example, a user may have a Microsoft Excel document that several people need to work on. The user may open the document on his computer and share it with others participants. Other participants can provide their comments directly in the document. Only the person who has opened the document is required to have the program on his computer. Other participants can work on the document without having the program. Only one person, however, can be in control of a shared program at a time.

To share a program, the user clicks the “Share Program” button, and then, in the “Sharing” dialog box, clicks the name of the program that the user wants to share. Finally, the user clicks “Share”. If the users share a Windows Explorer window, such as My Computer, Control Panel, or a folder on his computer, he will be sharing all Explorer windows he has opened. Also, once he has shared such a window, every program he starts while he is still in the meeting session is shared with the other participants automatically.

To allow control of a shared program, the user just clicks “Allow Control” button in the “Sharing” dialog box; then in the main NetMeeting window, right-clicks the name of a person he wants to work in the program, and then clicks “Grant Control”.

To work in a program shared by someone else, the user clicks “Request Control” on the “Control” menu of the shared program window. Only participants who have NetMeeting installed can work in a shared program. The person who shared the program must click “Allow Control” in the “Sharing” dialog box before he can click “Request Control”. When the user clicks “Request Control”, the person who shared the program receives a confirmation message and must click “Accept” before the user can work in the shared program. If a document is created during collaboration, only the person who shared the program can distribute the document.

Note that in the framework of NetMeeting, a user can neither bring a third-party Web service into a session without leaving the session and spending a number of navigating steps, nor bring an instant messaging session into a local application which is being used by one or both of the users in the session.

Another example is MSN Messenger, which is an instant messenger application similar to NetMeeting. The application provides a GUI from which users can enter and post textual messages. The GUI includes a number of functional links such as “invite someone to the conversation”, “send a file or photo”, “send e-mail”, “browse the Web together”, “ask for remote assistance”, “start application sharing”, “start whiteboard”, “make a phone call”, etc. In the framework of MSN Messenger, however, a user can neither bring a third-party Web service into a session without leaving the session and spending a number of navigating steps, nor bring an instant messaging session into a local application which is being used by one or both of the users in the instant messaging session.

Another example is Yahoo! Messenger, which is an instant messenger application associated with Yahoo's Internet Services. Similar to MSN Messenger, Yahoo! Messenger provides a GUI from which the users can enter and post textual messages. The GUI includes a number of functional links such as “send a file”, “invite a friend to see Webcam”, “invite a friend to enable voice”, “invite a friend to a multi-user conference”, and “select an IMVironment”, etc.

Yahoo! Messenger's IMVrionment feature brings online photo sharing experience into the instant messaging session by entirely loading a graphic content into the communication window. For example, when two users are in an instant messaging session, if the first user selects a photo sharing IMVrionment, the environment on the second user is also affected and modified based on the first user's action. The major problem in Yahoo! Messenger version 5.0 is that it is vulnerable to a denial of service attack, caused by a buffer overflow in the IMvironment field of the Yahoo protocol. By sending a message containing an overly large IMvironment field using a malicious Yahoo! Messenger client, a remote attacker could overflow a buffer and cause the recipient's Messenger client to crash.

Yet another example is AOL's IM and Chat, which uses a similar GUI including a message entry box and message display box. The GUI also includes a “music share” link which takes the user to audio or audio-video programs. To share a music program, the user clicks on the icon of the “music share”. The user is then returned a pop-up screen with various options. After the user clicks on an icon or title representative of a music program, a hyperlink enters the display box automatically. The selected program is then launched in the computer of the user who clicks the link.

Existing instant messaging client applications are primarily used for exchanging textual messages, and are monetized by displaying ads that add no real value to users' experience. Although some of them allow users to share Web content in a limited sense, none of them adopts a framework facilitated with easy-to-use brokerage to bring external resources, such as a third-party Web service or a local application, into an instant messaging session or even bring the instant session into the local application which is being used.

What is desired is a framework in which a third-party service on the Internet can be seamlessly incorporated into an instant messenger environment without necessarily loading the entire application interface of the third-party service, so that a user can share the chosen resource with another user during an instant messaging session.

What is further desired is that the framework enables the user to seamless bring a local application into the instant messaging session or even bring the instant messaging session into the local application.

What is further desired is that the framework enables the user to seamlessly bring web content and services into a user's immediate authoring environment.

What is further desired is that the framework enables the user to seamlessly share bot-agents services in instant messaging sessions among multiple users.

### SUMMARY OF THE INVENTION

The invention provides a rich experience instant messaging (IM) framework that allows a number of software agents, called IMLets, to be stacked on top of an instant messenger application. Each of the software agents establishes a connection with a specific third-party service on the Internet. The end users of the IM session can share one or more third-party services through the agents without need of leaving the session. In other words, the users can use the third-party services in the IM session and share the results or collaborate with the facilities offered by the services represented by the software agents.

In one preferred embodiment of the invention, the rich experience framework includes a graphical user interface which has a window for registration and activation of the software agents. The graphical user interface can be either attached to, or detached from the traditional instant messenger interface. Registration of a software agent makes it immediately stacked on the user's instant messenger application environment and thus makes a third-party service represented by the agent immediately available for the user. The user chooses one or more software agents for registration from a variety of options. A list of the options is frequently updated by the IM service provider. The user may change his registrations from time to time.

Activation of a software agent makes the third-party Web service represented by the agent immediately accessible in an IM session. The graphical user interface provides a list of the user-registered software agents. The user can activate any of them by one or more mouse-clicks or simply by dragging it to the communication window. When the software agent is activated, the users can directly share the agent's usage results. For example, the user may activate a software agent associated with a third-party instant-translation service which enables the users to communicate using different languages without a need to load the third-party service application into the users' computers. For another example, the user may invite another user to watch a movie by inserting a movie element provided by an online movie service. Once the software agent is activated, the users can share the selected online service in the session. The data exchange between the users and the selected online service is supported by Web service interfaces, such as SOAP/XML/HTTP, and the related protocols.

A software agent can also represent a local application in the user's computer. With assistance of the software agent, the users can not only share the application in an IM session, but can communicate to each other within the application as well.

In another preferred embodiment, the user can easily associate a visual cue, such as an icon or its alias, of a software agent with the screen name of a certain contact in the user's friend list or buddy list. Whenever the user and the contact meet in an IM session, the visual cue enters the IM environment with the contact's screen name. The user may simply, for example, click on the visual cue associated with the contact's screen name, and the service represented by the software agent is instantly brought into the IM session. A software agent's icon and its alias may appear in many different places. For example, it appears in the list of registered agents or the list of unregistered agents. It can also be spatially associated with the screen name of a contact in the contact list. When several different agents' icons or aliases are associated with one contact, the icons or aliases can be arranged in a sequence determined by the user's prior use with the contact or by the user's frequency of use, with the contact, of the third-party service represented by the application agent. When the contact's screen name appears in the instant messenger application's communication window, the associated icons or aliases come with the screen name. In this case, the user may activate the application agent by clicking the icon or alias. The contact may invite the user to activate the application agent if the contact himself has not registered the software agent.

In another preferred embodiment, the software agents are configured to establish a connection with respective third party online services and to enable online users to seamlessly insert content provided by the third party online services into the users' immediate authoring environment, such as, for example, into a Weblog application environment, and/or into an electronic mail composition environment.

In yet another preferred embodiment, the software agents are configured to establish a connection with respective third party online services and to enable online users to incorporate and seamlessly share external bot-agents services into the users' IM sessions.

### BRIEF DESCRIPTION OF THE DRAWINGS

FIG. 1A is a block diagram illustrating a rich experience instant messaging (IM) system according to the invention;

FIG. 1B is a block diagram illustrating a data flow model of the rich experience IM system of FIG. 1A;

FIG. 2 is a schematic diagram illustrating an exemplary rich experience IM system according to the invention;

FIG. 3 is a schematic block diagram illustrating one preferred embodiment of an integrated graphical user interface of the instant messenger application according to the invention;

FIG. 4 is a schematic block diagram illustrating a situation where the participants of an IM session according to FIG. 3 are sharing a movie program supported by a third-party;

FIG. 5A is a schematic diagram showing that the icons of the user-registered software agents (IMLets) are associated with the screen names in the user's list of contacts;

FIG. 5B is a schematic diagram showing that the icons (or the aliases) of the user-registered software agents (IMLets) are associated with the screen names in the IM session;

FIG. 6 is a flow diagram illustrating a method for sharing a third-party service in an IM session according to one preferred embodiment of the invention;

FIG. 7 is a schematic block diagram illustrating an application of the invention wherein two end-users are communicating in an IM session via an IM bot represented by a translation IMLet;

FIG. 8 is a schematic block diagram illustrating an application of the invention wherein a visually disabled user and a regular user are communicating in an IM session via a speech synthesis system represented by a speech synthesis IMLet;

FIG. 9 is a schematic block diagram illustrating an application of the invention wherein users seamlessly insert content provided by the third party online services into the users' immediate authoring environment;

FIGS. 10A and 10B illustrate exemplary interfaces to seamlessly insert content provided by the third party online services into the users' immediate authoring environment; and

FIG. 11 is schematic block diagram illustrating an application of the invention wherein users incorporate and seamlessly share external bot-agents services into the users' IM sessions.

### DETAILED DESCRIPTION OF THE INVENTION

The invention provides an application program interface (API) system that allows a number of software agents to be stacked on top of an instant messaging (IM) application. Each of the software agents can establish a connection between the local resources in the user's computer and a remote distributed third-party service on the Internet. The users can share one or more third-party services through the software agents in an IM session.

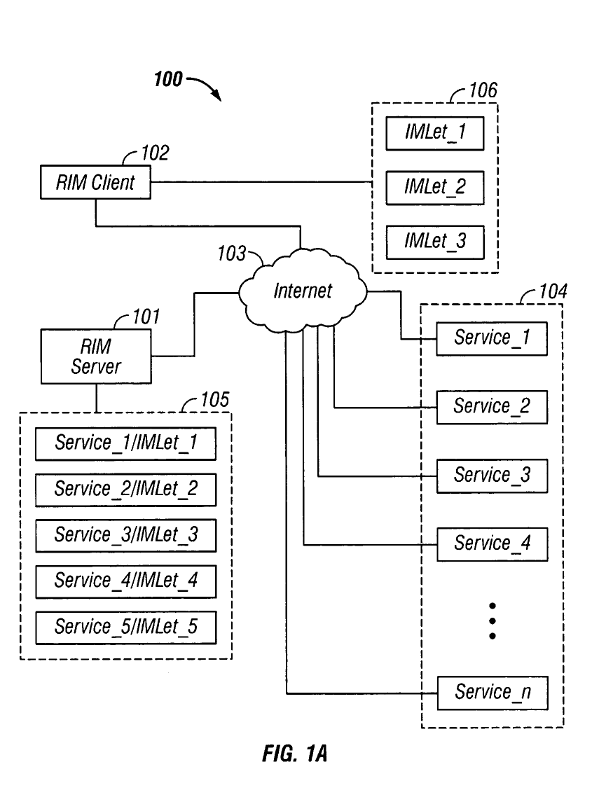

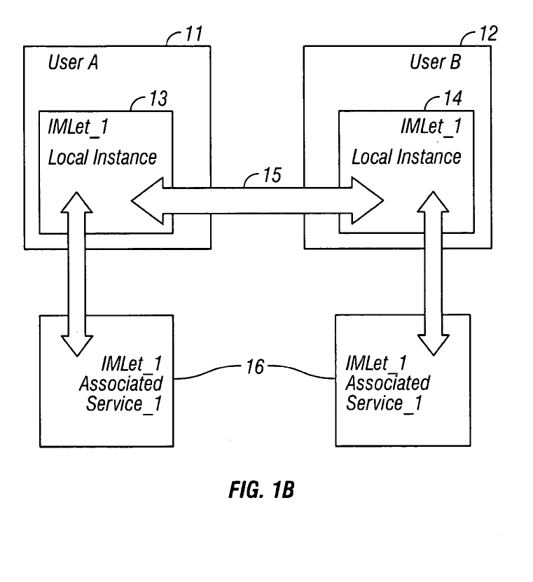

FIG. 1A is a block diagram illustrating a rich experience instant messaging (RIM) system 100 according to the invention. The system includes a RIM server 101 which provides IM service and a plurality of RIM clients, e.g. RIM Client 102, running on the users' computing devices such as desktops, laptops or PDAs, etc. RIM server 101 and the users' devices are coupled to the Internet 103. There is a plurality of third-party services (Service_1 through Service_n) 104 coupled to the Internet. RIM server 101 has contracted with some third-party services, e.g. Service_1 through Service_5, 105 and provides an application agent, called IMLet, for each of the contracted services 105. The IMLet, when registered by a user of the RIM service, runs on the top of the RIM service application. The user may choose any of the IMLets supported by the RIM server 101 for registration. For example, although the RIM service supports IMLet_1 through IMLet_5, the user using RIM client 102 has only registered IMLet_1 through IMLet_3.

FIG. 1B is a block diagram illustrating a data flow model of the RIM system 100 of FIG. 1A. User A at the device 11 and User B at the device 12 are communicating in an IM session 15 supported by the RIM application. User A activates an IMLet, e.g. IMLet_1, to share the associated Web service 16, i.e. Service_1, with User B. Through the IMLet_1's local instance 13 at the device 11, User A exchanges data directly with Service_1. Similarly, through the IMLet_1's local instance 14 at the device 12, User B exchanges data directly with Service_1. Note that an IMLet itself may proactively send an update to the other end. For example, User A is using a camera connection as IMLet_3, the IMLet_3 can from time to time use the channel to update the other end to notify when the camera image is available or not. The IMLet can use the IM session flow itself to address a message to the other end, e.g. to another IMLet, or can simply use its own channel of communication. When an IMLet uses the IM session flow, its application data is not displayed to the users.

An IMLet can also act as the representation of a local application exposed to the user's IM session. In this case, the users can collaborate by exchanging materials and composition resources that are produced in using the local application in the IM session. For example, via the IMLet, the users can collaborate in creating, updating, and publishing Web content to any HTML Web site. When the IMLet is activated, the represented local application can access the user's IM session to facilitate communication with the both ends. For another example, when User A is using a word processor application, he might want to communicate with User B via the word processing application, such as copying and pasting the paragraph to User B's word processor. In this situation, assume that User A is logged on the IM and the IMLet for the word processor is activated, User A can gain new menu items on the word processor interface which allows User A to share objects with User B.

In various deployments such as these illustrated hereafter, an external application, i.e. a third-party service on the Internet or a local application in the user's computing device, can be represented by more than one IMLets. In that case, one IMLet can act as the agent for a specific function of the external application. For example, when a multi-function IM bot is involved, one IMLet can be a representative of the IM bot's auto-translation function; another IMLet can be a representative of its Web search function; yet another can be a representative of its shopping function. Similarly, in a multi-lingual translation service, each language-pair, e.g. English [symbol] Portuguese, Spanish [symbol] Russian, etc. can be represented by a single IMLet. For another example, in an on-line music or radio service, each specific section or program can be represented by a single IMLet.

To maximize the users' IM experience, the visual cue (such as an icon or its alias) of an IMLet and the activation process for the IMLet can be incorporated in the RIM application's user interface in a user-friendly manner. For example, the user can conveniently associate one or more IMLets with a certain contact in his friend-list or buddy list. When the user and the contact meet in an IM session, the IMLets associated with the contact are already stacked on the RIM application. When the user clicks on the icon of the IMLet, the service represented by the IMLet is instantly brought into the IM session. The IMLet's icon and its alias may appear in many different circumstances. For example, it appears in the list of registered IMLets or the list of unregistered IMLets. It can also be spatially associated with the screen name of a contact in the contact list. When two or more IMLets are associated with one contact, the icons of these IMLets can be arranged in a sequence determined by the user's prior use with the contact or by the user's frequency of use, with the contact, of the third-party service represented by the IMLet. When the contact's screen name appears in the RIM application's communication window, the associated icons or aliases come with the screen name. In this case, the user may activate the IMLet by clicking the icon or alias. The contact may ask the user to activate the IMLet if the contact himself has not registered the IMLet.

In order to avoid possibility of security flaws, a protocol, deployed on top of the IM application, is required. The protocol supports the relationships among the users for the IM session, the agent, i.e. the IMLet, representative of the external entity, i.e. an application software or service, and the agent's action. This protocol adds meta-data that is pertinent to the agent for the given user session. Assume a word processor is involved, the message between User A and User B would become:

AgentFrom:Word_Processor;
AgentTo: Word_Processor;
SessionInstance: 1;
Agent_Command: Save_file;
...

This represents a message that was sent from, for example, the device 11, User A, via IMLet word processor, addressing the same agent on the other end (the device 12, User B). This type of agent-to-agent message using IM session works in the communication protocol level without showing as text to the users. Note that the IMLet, which operates as agent in the user's IM session, also addresses other applications on the other side via using the user's communication channel and a message protocol. Particularly, the IMLet sends encoded data via the user's message protocol. For example, when application A is addressing Application B on the other end, the data transferred can be a sequence of characters that represents binary data.

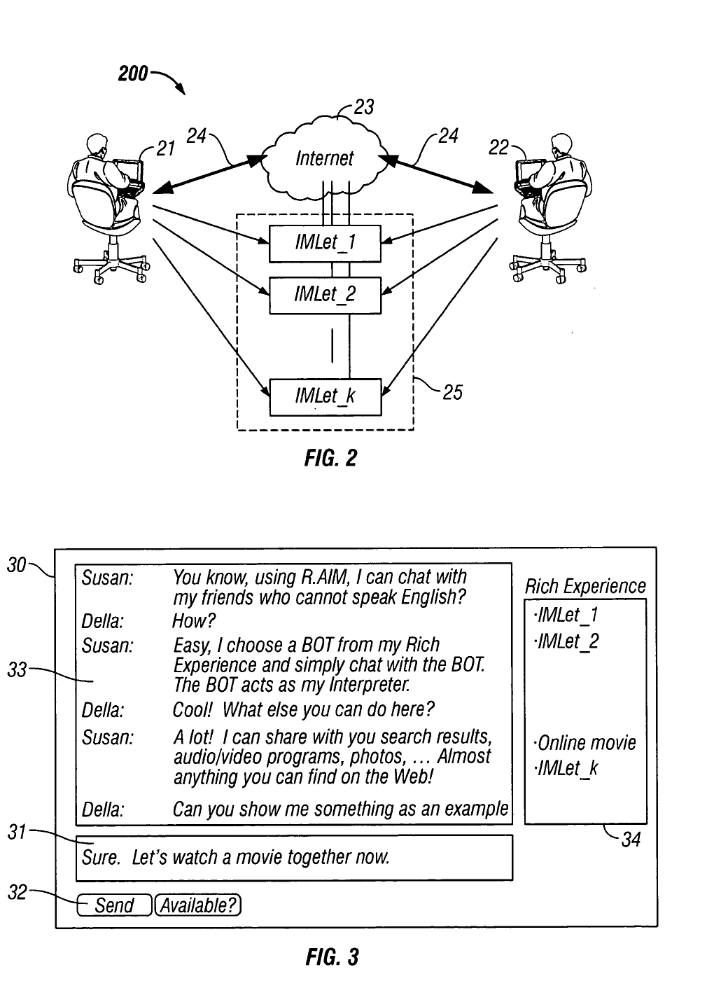

FIG. 2 is a schematic diagram illustrating an exemplary rich experience instant messaging system 200 according to the invention. User A at the device 21 and User B at the device 22 are communicating across the Internet 23 in an instant messaging IM) session 24. A rich experience instant messenger (RIM) application runs in each user's computing device. The RIM application provides a first graphical user interface which enables each user to enter a message and display the message in the communication window. The communication window is visible to both parties. In addition, the application provides a second graphical user interface which enables a user to register one or more software agents, i.e. the IMlets 25, from a variety of options provided by the RIM server. The second graphical user interface also enables the user to activate one or more of the user-registered IMLets in an instant messaging session. The first graphical user interface and the second graphical user interface can be either separate from each other, or combined into an integrated user interface. There is also the case, for example, where the software agent can provide a simulated interface and the user may not even realize that he is not using the IM user interface anymore, and instead, he is now using the IM session protocol infrastructure. Nevertheless, the IMLet itself may have its own user interface which does not necessarily look like the IM user interface.

The RIM application uses connectivity infrastructures such as Web services API as well as other Web based protocols and technologies to integrate third-party services into the IM session. In terms of requirements and reusability of components, the RIM application creates a placeholder environment wherein the IMLets participate in the IM session accessing the Instant Messenger API, the Web services API as well as other Web-oriented APIs.

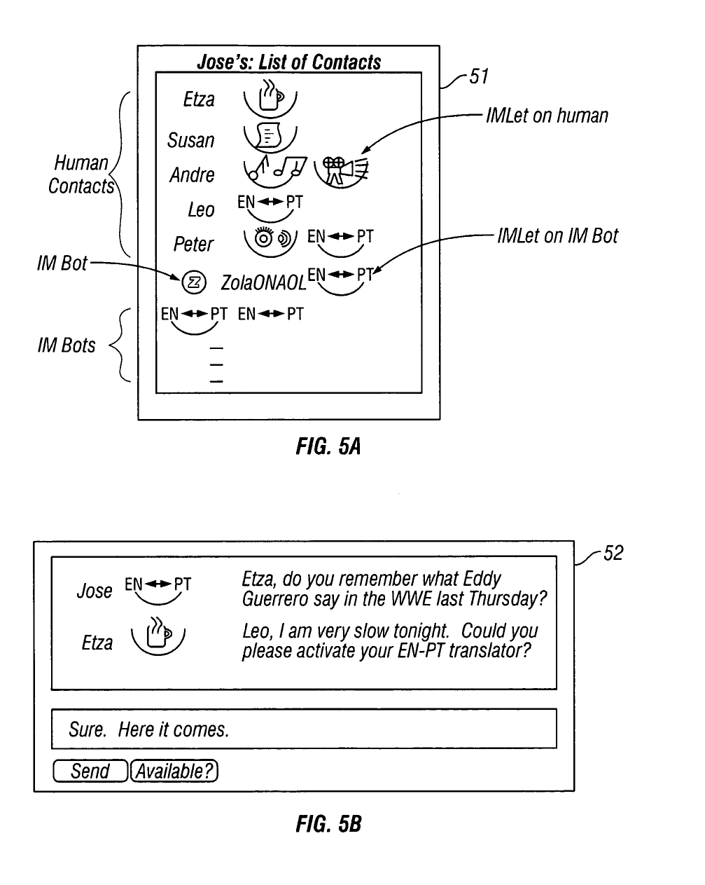

In various implementations such as these described herein, the IMLets can be registered either in a separate list as illustrated in FIG. 3 or in the user's list of contact as illustrated in FIG. 5A. Upon registration by the user, an IMLet is immediately stacked in the user's instant messenger application environment and thus makes a third-party service represented by the IMLet immediately available for the user. The user chooses one or more IMLets for registration from a list of options which is frequently updated by the RIM service provider. The user may register new IMLets and unregister (unsubscribe) the registered ones at any time. The registration or unregistration can be done by a number of mouse-clicks or by dragging the icon or the title of the IMLet from the list of unregistered services to the registered services or vice versa.

Upon activation by the user, the IMLet makes the third-party service represented by the IMLet immediately accessible in the IM session. The second graphical user interface as mentioned above provides a list of IMLets registered by the user. The user can activate any of them by giving simple commands such as one or more mouse-clicks or by dragging a symbol, e.g. an icon or a title, representative of the IMLet into the communication window.

Once the IMLet is activated, the users can share the selected online service in the IM session. The data exchange between the users and the selected online service is supported by Web service interfaces, such as SOAP/XML/HTTP, and the related protocols.

In various deployments such as these illustrated herein, an IMLet can be coupled to an IM bot, which is an interactive IM user agent represented by a software application. Once the IMLet is activated, the user can communicate either in the IM's user interface or in the IM bot's user interface, depending on implementations. An example of IM bots is the ZolaonAOL supported by America Online. Using AOL instant messenger application, the user can simply add the buddy “ZolaonAOL” to his Buddy List, i.e. the list of contacts. A user can communicate with ZolaonAOL (or the screen name zola), for example, asking for what movies is playing around a specific area.

FIG. 3 is a schematic block diagram illustrating one preferred embodiment of an integrated graphical user interface 30 of the rich experience instant messenger (RIM) application according to the invention. A user types textual message in the entry box 31. Upon clicking on the send button 32, the user's message is posted in the communication window 33 which is visible to all participants of the IM session. The user may instantly share a third-party service with other participants using the rich experience window 34. From window 34, the user can access a list of unregistered IMLets and a list of registered IMLets. The user can choose any one from the unregistered IMLets for registration by giving simple commands such as one or more mouse-clicks or dragging a symbol, e.g. an icon or a title, representing the IMLet to the list of the registered IMLets. Similarly, the user can unregister or unsubscribe a registered IMLet by giving simple commands such as one or more mouse-clicks or dragging the symbol to the list of the unregistered IMLets. Note that in FIG. 3 only an exemplary list of registered IMLets is illustrated. Although the list for registered IMLets and the list for unregistered IMLets can be deployed in different forms, the essence of the structures is basically the same.

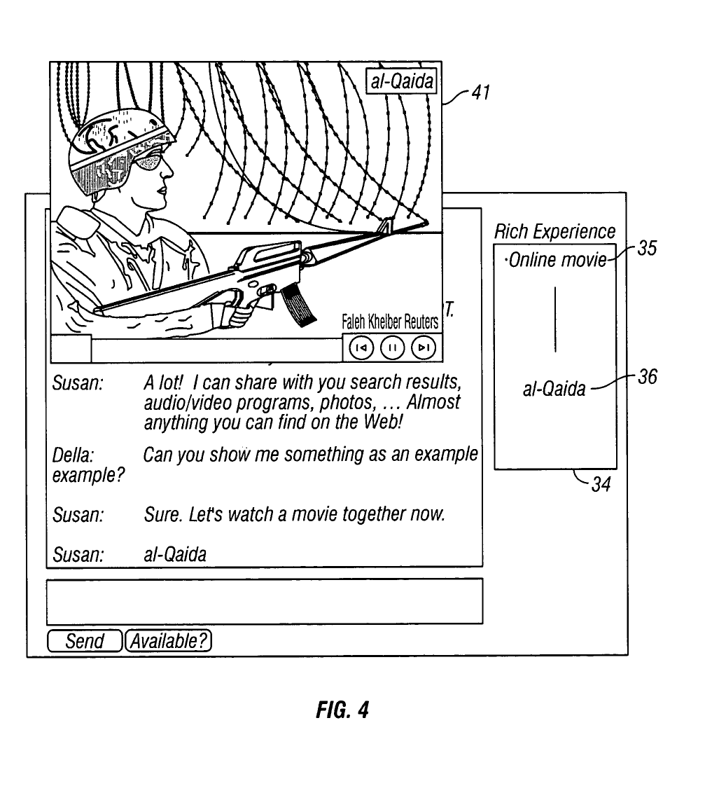

Now referring to FIG. 4, when Susan, one of the users, decides to share an online movie with the other user, she needs first to activate an IMLet representative of “Online Movie” 35, for example, by clicking the IMLet's icon or choosing “activation” from a pull-down menu. Then, she needs to choose a movie from a list. In the example illustrated in FIG. 4, Susan chooses the movie “al-Qaida” 36. When she clicks on the movie title, a link enters the communication window 33. When Della, the other user, clicks on the link, the movie starts on a pop-up screen 41.

Note that the IMLet can simply provide a user interface to the user. As the user clicks and chooses something, the IMLet itself is addressing the other agent directly via the IM session and the third-party application or service starts acting on top of the IM session on the user's behalf.

There are various different implementations of the activation process. In one of the implementations, when a user clicks the movie title (or an icon), the movie starts on a pop-up screen which appears in both users' computer screens at the same time.

In another implementation, when a user clicks the movie title (or an icon), a system message enters the communication window 33 (see FIG. 3). The system message may be akin to “You are invited to share <al-Qaida>. Please click anywhere of this message to start the sharing.” When the invitee clicks the message, the movie starts on a pop-up screen which appears in both users' computer screen at the same time.

Yet in another implementation, the users may share a movie in a real time but non-synchronous manner. For example, when a user clicks the movie title (or an icon), the movie starts on a pop-up screen which only appears in the inviting user's computer, and at the same time a system message is posted in the communication window 33. When the invitee clicks the message or a link included in the message, the movie starts on a pop-up screen which appears in the invitee's computer screen. The users may choose to synchronize their sharing at any time.

In various implementations such as these illustrated herein, each IMLet can be represented by a distinct visual cue such as an icon and its alias. To maximize the users' IM experience, the visual cue and the activation process for the IMLets can be incorporated in the IM application's user interface in a very convenient manner. For example, the user can easily associate one or more IMLets with a certain contact in his friend-list or buddy list. Whenever the user and a contact meet in an IM session, the IMLets associated with the contact come into the session with the contact's screen name. The user may simply, for example, click on the icon of an IMLet, and the service represented by the IMLet will be instantly brought into the IM session. An IMLet's icon and its alias may appear in many different places. For example, it appears in the list of registered IMLets or the list of unregistered IMLets. It can also be spatially associated with the name of a contact in the contact list. When several IMLets are associated with one contact, the icons can be arranged in a sequence determined by the user's prior use with the contact or by the user's frequency of use, with the contact, of the third-party service represented by the IMLet. FIG. 5A illustrates an exemplary List of Contacts (or Buddy List) 51 wherein the user (with a screen name “Jose”) has five human contacts (Etza, Susan, Andre, Leo, and Peter), one IM bot, and various IMLets in his list of contacts. Etza, Susan or Leo, each has one IMLet associated. Andre or Peter each has two IMLets associated. When a contact's screen name appears in the instant messenger application's communication window as illustrated in FIG. 5B, the associated icon or alias comes with the screen name. In this case, the user (Jose), with whom an “English-Portuguese Translation” IMLet is associated, may initiate the application agent by clicking the icon “EN [symbol] PT”. Jose's IM partner Etza can also ask Jose to activate the application agent represented by the IMLet “EN [symbol] PT” in the event Etza herself has not registered the application agent.

Note that an IMLet can be associated not only to a human contact, but also to an agent program such as an IM bot. When User A is talking to an IM bot such as ZolaOnAol, User A can choose to use an auto-translation service via an IMLet. For example, ZolaOnAol cannot understand Chinese, but a Chinese user may talk to Zola in Chinese and get Zola's responses via an IMLet which connects to an English [symbol] Chinese translation service. This scenario can be further extended as below:
User A← . . . →Bot X+IMLet← . . . →User B

In this scheme, User A uses Bot X to communicate with User B or more users at the same time. Bot X acts and offers a service like a chat bot. Bot X passes User A's message to User B or vice versa. Here both users receive the benefits of the IMLet serving on Bot X in the IM session. One example is the auto-translation service as described hereafter. Another example is the service of automatically recording the communication flow. Note that all the cases are simply based on the same concept that IMLets can be attached to a human IM user or a software agent user which is an IM bot.

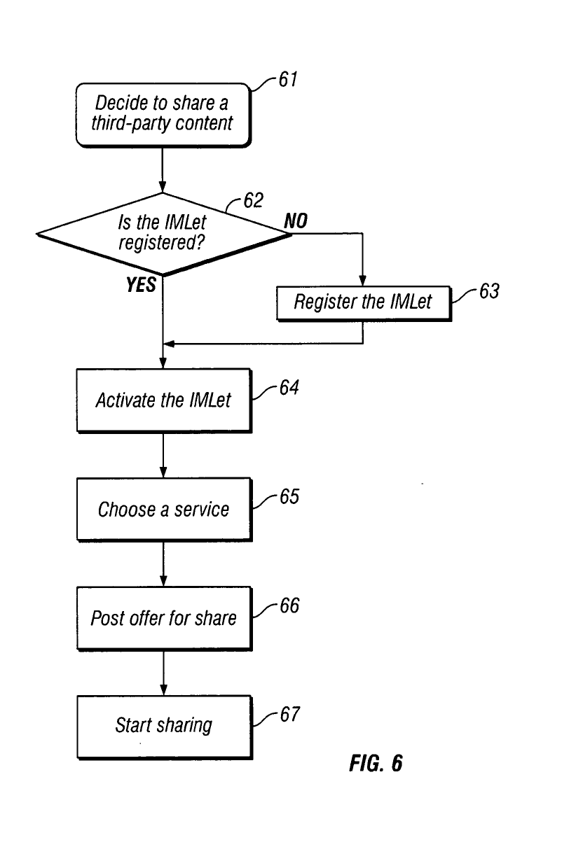

FIG. 6 is a flow diagram illustrating a method for sharing a third-party service in an instant messaging session according to one preferred embodiment of the invention. The method includes the steps of:

Step 61: The user decides to share with other participants in the session a third-party online service or content on the Internet or even a local application.

Step 62: The user checks whether a registered IMLet, i.e. a software agent representative of the third-party service exists.

Step 63: If the check result in Step 62 is NO, then register the IMLet and continue on Step 64. The registration may be accomplished, for example, by dragging a link or an icon from the unregistered list to the registered list, or by a number of mouse-clicks. For another example, the registration can be done through the user's personal settings or preferences. Yet for another example, in situations where the IM application can be exposed to external applications (such as a word processor) via IMLets, the user can simply query the IM application for registration.

Step 64: If the check result in Step 62 is YES, then activate the IMLet. The activation may be accomplished, for example, by a single or double clicks.

Step 65: In case the third-party service provider provides more than one service or content, the user chooses one service or content from a list of options.

Step 66: Post an invitation message to the other participant(s) to share the selected service or content.

Step 67: Upon acceptance of the invitation, the invitee may access the third-party service or content.

Note that the steps 66-67 can be optional because the message can simply be addressed between the IMLets in both sides.

In another preferred embodiment, the user activates the IMLet by dragging its name or icon to the communication window 33. When the user releases the mouse, a system message for invitation is automatically posted in the communication window 33 which is visible to the session participants. Upon the invitee's acceptance of the invitation by giving an acceptance command such as clicking on the system message or on a link included in the system message, the selected service or content becomes immediately accessible to the invitee. For some progressive content, such as audio/video programs, the users can even choose to share the content synchronously or non-synchronously.

The IMLets may be representative of many different kinds of remote contents, applications and services provided by third-parties. The following is a list with some examples other than movie sharing described above:

Real Time Chat Translation

In a chat session where users do not speak the same language, a user may choose to activate an IMLet that leverages a remote Web service to translate strings of text, such as the Babelfish Web service, so that the users can communicate seamlessly regardless of their native languages. The translation service stays active during the IM session, translating content as it is typed. The IMLet in this case is the intermediary application that filters the text that is written and connects with the translation service providing the results and plugging them into the session. The intermediary application is basically an overlay of JavaScript code that can query the translation service. It also provides a setting means from which the user chooses a language pair for translation such as “English [symbol] Portuguese”.

There can be many different implementations of the IMLet for instant translation. In one of the implementation, the following steps are performed:
A user activates an IMLet that represents an interactive translation-chat service with extended functionality.
The IMLet asks the user (a) whom do you want to talk? (b) What languages do you want to translate?
The user enters screen name Etza and chooses language “English [symbol] Portuguese”.
If Etza is not online, a message returns to the user saying Etza is not available.
If Etza is online, the user starts writing English in the entry window.
When the user clicks “SEND”, the Portuguese translation of the user's message enters the communication window 33 (both the user and Etza can see the Portuguese translation).
When Etza responds in Portuguese, the English translation of Etza's message enters the communication window 33.

In a typical embodiment, the translation-chat service operates as a two-way agent. The IMLet representative of the translation-chat service sends commands to the translation-chat service, such as asking the translation-chat service to connect User A with User B. For example, an icon of EN_PT_via_Bot can be provided via the IMLet representative of the translation-chat service. So when the user clicks the EN_PT_via_Bot icon, the IMLet connects the user with the translation-chat service and commands the translation-chat service to engage with the other user.

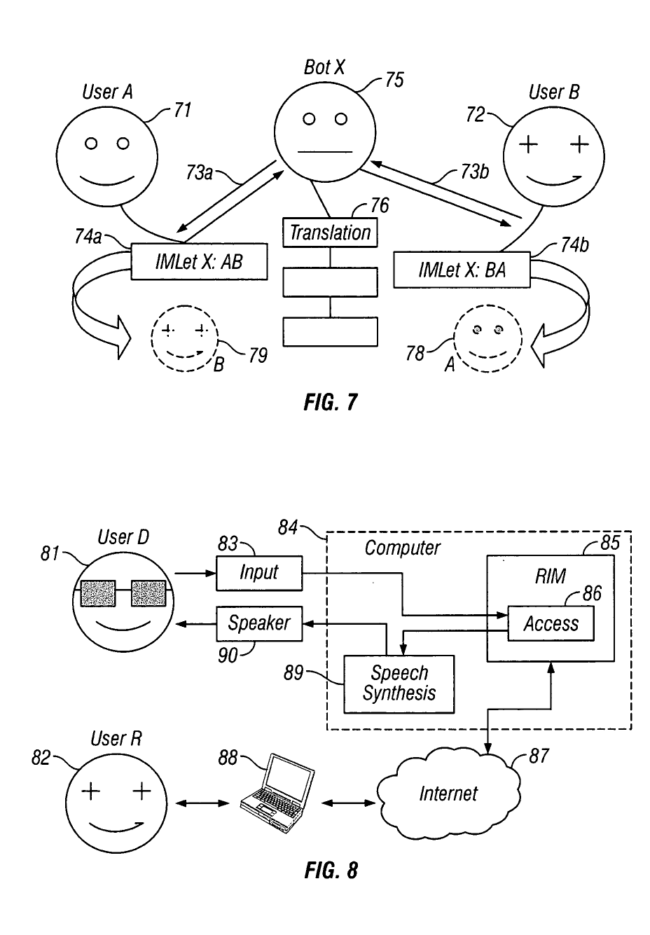

FIG. 7 illustrates an exemplary scheme wherein User A 71 and User B 72 are communicating in an IM session 73a/b. User A activates IMLet X 74 which is associated with a multi-function Bot X 75. One of its functions is automatic translation 76. IMLet X 74 (74a in User A's side, 74b in User B's side) sends to and receives messages from Bot X 75. By simple configuration, the user can activate the translation function 76. Once the translation function 76 is activated, the instant translation service is brought into the session 73a/b. In this case, the communication “User A<— . . . —>User B” is actually accomplished by “User A <—>Bot X <—>User B”. In other words, User A communicates with Bot X and Bot X communicates with User B as illustrated by the following steps:
Amy (User A) adds the IMLet X, 74a, to her IM application;
Babee (User B) adds the same IMLet, 74b, to his IM application;
Amy->Bot X: Bot X, connect me to Babee.
Bot X->Amy: Wait.
Bot X->Babee: Amy wants to talk with you? Do you accept?
Babee->Bot X: Yes.
Bot X establishes the association of Amy-Babee and is ready for routing messages.
Bot X->Amy: You're now talking with Babee.
Amy->bot X: Hi Babee!
Bot X->Babee: Hi Babee!
Babee->bot X: Hey how are ye?
Bot X->Amy: Hey how are ye?

So Amy and Babee are now engaging into a conversation in English. Suddenly, Babee wants translation:
Babee->Bot X: Bot X, set translation English-Portuguese.
Bot X->Babee: Okay. Now messages you send to Amy will be in Portuguese.
Babee->Bot X: Amy, do you like Brazil?
Bot X->Amy: Amy, voce gosta do Brasil?

Note that Babee can always set Bot X and request Bot X to associate a third-party. When Babee says “Bot X, set translation to English-Portuguese”, the Bot X associates and activates the third-party translation software 76. In a typical implementation, when User A and User B are chatting via Bot X, User A should be able to see a virtual representation of User B such as the icon 79, and User B should be able to see a virtual representation of User A such as the icon 78. The IMLet here is actually the helper application that eliminates the need of all the specific commands to the translation bot because the IMLet can do that “hidden messages” with third-party applications, e.g. the translation bot herein, and thus can simplify the processes required.

Speech Synthesis

The speech synthesis services specifically designed for helping users with disabilities can also be stacked on the instant messenger application using one or more IMLets. This case is similar to the translation scenario described above. Some people need translation service because they might not be able to communicate in a foreign language. Similarly, some people need speech synthesis service because they might have visual disabilities. One example of the speech synthesis services is a screen reader which helps the disabled to read Web pages. In the rich experience instant messaging system according to this invention, one or more IMLets representative of the speech synthesis services can be registered and activated. The IMLets, together with other speech-enabled software applications, help the visually disabled to communicate in an IM session. FIG. 8 illustrates a rich experience instant messaging (RIM) system which enables a visually disabled user 81 (User D) to communicate with other regular IM user 82 (User R). User D 81 needs an input interface 83 such as a key board or a speech enabled input device to communicate with the computer 84 on which the RIM application 85 runs. There is also an accessibility agent 86 which is an IMLet stacked on the RIM application 85. The accessibility agent 86 helps the visually disabled user to access the RIM application 85 and communicates to User R via the Internet 87 and User R's computer 88. The accessibility agent 86 works with the speech synthesis application 89 to provide understandable responses to User D 81 via the speaking system 90.

Note that this scheme is useful in helping various entities to be in compliance with Federal law relating to accessibility for disabled, e.g. Section 508 of the Rehabilitation Act, see http://www.section508.gov. Section 508 requires that Federal agencies' electronic and information technology is accessible to users with disabilities. Using the IMLet-extended instant messaging system, governmental and private entities can provide on-line answers and support to more users than before.

Automatic Publishing

During an instant messaging session, a conversation can be published to a Web log service via an IMLet specifically implemented for this purpose.

Picture Sharing

An IMLet for picture sharing service may be incorporated into the instant messenger system. The IMLet leverages the existing Web services and enable sharing of the pictures in an instant messaging session.

Map Sharing

An IMLet for map reference sharing may be incorporated into the instant messenger system. The IMLet leverages the existing Web services and enable users to query and share data (driving directions to an event, map of a location) from Web-based map service providers, such as mapquest.

Other Applications

The framework according to this invention adds value by giving the user the ability to share and compose data beyond text, images or Web links. All the content, applications and services that provided via many different IMLets become pieces that can be composed creating rich composition. Users are able to compose content that can be interactive and connect with content providers or online services.

The framework can also be used with other environments than instant messenger environments. For example, IMLets can be used as assistant tools during the authoring of information, such as Weblogs. During a blog publishing authoring session, a user can use an assistant application, such as an IMLet, to insert a rich content provided by a third-party online service. Another example is to insert a content provided by a third-party online service during the composition of e-mail. A user may be interested in inserting stock quotes. Instead copying and pasting from a Web site (the user has to leave the email application to do so), the user can simply query the Stock Quote IMLet and insert the result into the composition via a single click.

Authoring of Information

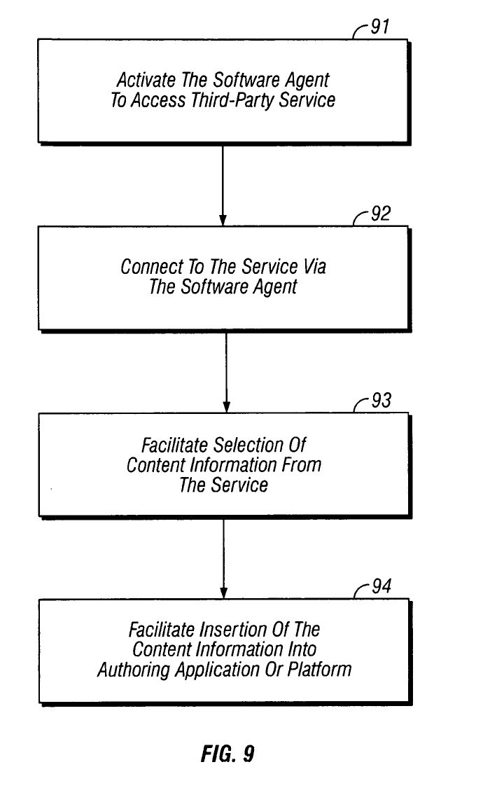

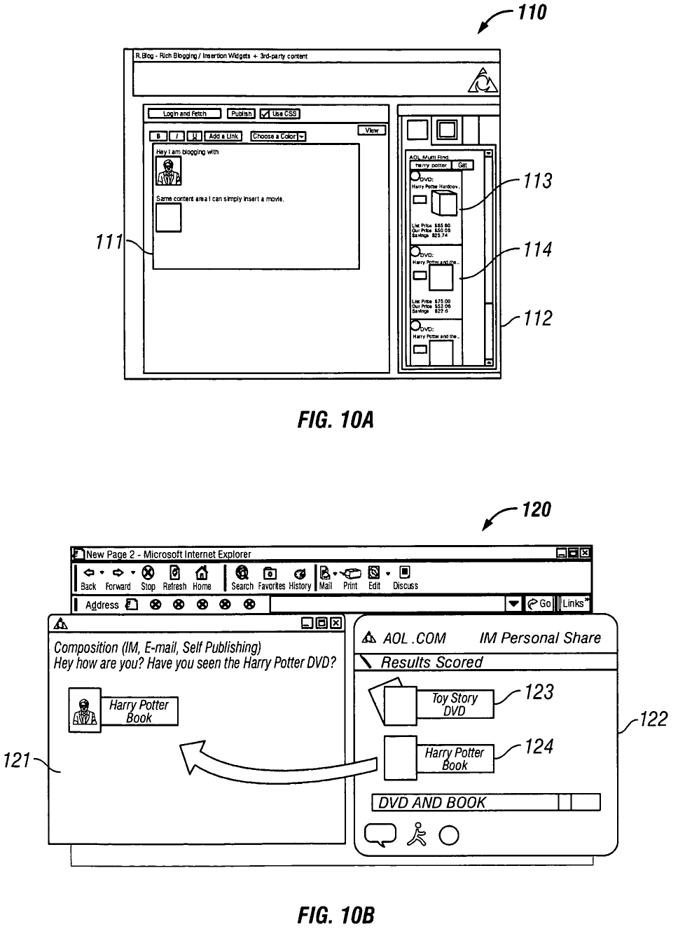

FIG. 9 is a schematic block diagram illustrating an application of the invention wherein users seamlessly insert content provided by the third party online services into the users' immediate authoring environment. FIGS. 10A and 10B illustrate exemplary interfaces to seamlessly insert content provided by the third party online services into the users' immediate authoring environment.

As illustrated in FIG. 9, in one embodiment, at processing block 91, a software application agent, such as an IMLet, is activated to access one or more external resources, such as, for example, third party online services. The user typically activates the software agent with a conventional mouse click command. In an alternate embodiment, multiple software agents may be activated, each software agent being configured to access a specific external resource.

At processing block 92, the client application running on the user's client device connects to the third party service via the activated software agent. In one embodiment, each of the activated software agents establishes a connection with a corresponding third party online service server and the user accesses the service via the client application and the Internet 103.

At processing block 93, selection of content information from the third party online service is facilitated.

In one embodiment, as illustrated in FIG. 10A, a client authoring application 110 contains an authoring interface area 111 and a service interface area 112. Content information from the third party online service is displayed within the service interface area 112 as one or more icons 113, 114. The service interface area 112 facilitates user selection of content information with a conventional mouse click command, such as, for example, selection of icons 113, 114. For example, when the client authoring application 110 is a movie blogging application, the service interface area 112 facilitates selection of icons representing real movies from a movie-related third party online service.

In an alternate embodiment, as illustrated in FIG. 10B, the client authoring application is an electronic mail (email) composition application 120, which contains an email authoring interface area 121 and a service interface area 122. Content information from the third party online service is displayed within the service interface area 122 as one or more icons 123, 124. The service interface area 122 facilitates user selection of content information with a conventional mouse click command, such as, for example, selection of icons 123, 124.

Referring back to FIG. 9, in one embodiment, at processing block 94, insertion of the content information into the authoring application or platform is facilitated. As illustrated in FIG. 10A, the authoring interface area 111 of the blogging application 110 facilitates insertion of the selected content information (icons 113, 114) into the authoring interface area 111 with a convention mouse click-and-drag command.

Similarly, as illustrated in FIG. 10B, the authoring interface area 121 of the email composition application 120 facilitates insertion of the selected content information into the body of an email message displayed in the authoring interface area 121 with a convention mouse click-and-drag command. Alternatively, the user may archive, share with other users, or add more content at a later time into the respective authoring application 110 or 120. Other examples of content information retrieved from respective servers supporting third party online services include, for example, news references, books, music references (including music streaming segments from online music services), compact discs, photo references or insertions, translation services, drawing insertions, voice recording references, references to other users' card information.

Sharing of External Bot-Agent Services

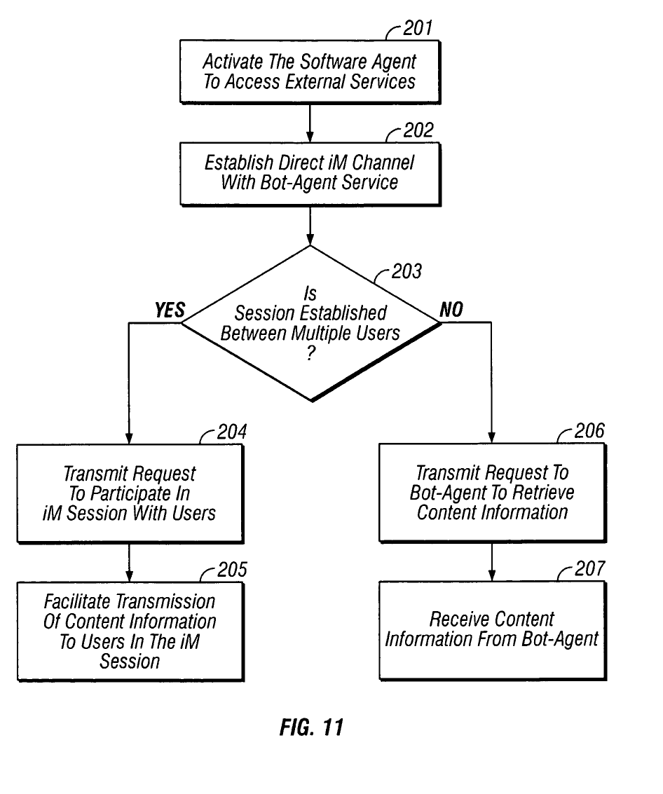

A method and system for using bot-agents as participants, mediators, and/or ghost servants in instant messaging (IM) sessions or conferences are described. A bot is a software agent that represents itself as an IM user. The system makes an IM bot-agent immediately available in an IM session such that the participants of the session may query or use the IM bot without leaving the IM session, as described in further detail below in connection with FIG. 11.

FIG. 11 is schematic block diagram illustrating an application of the invention wherein users incorporate and seamlessly share external bot-agents services into the users' IM sessions.

As illustrated in FIG. 11, at processing block 201, a software application agent, such as an IMLet, is activated to access one or more external resources, such as, for example, bot-agents services. In one embodiment, the user typically activates the software agent with a conventional mouse click command. In an alternate embodiment, multiple software agents may be activated, each software agent being configured to access a specific external resource.

At processing block 202, a direct communication channel, such as, for example, an instant messaging (IM) channel, is established with the bot-agent service. In one embodiment, the user establishes a direct IM channel with the bot-agent via a client communication application running on the user's client device and via the Internet 103, such as, for example, a client instant messaging application.

At processing block 203, a decision is made whether the IM session is established between multiple users. If multiple users participate in the IM session, then at processing block 204, a request to participate in the IM session with the users is transmitted. In one embodiment, one or more users request participation of the bot-agent in the current IM session. Subsequently, at processing block 205, transmission of content information to users in the IM session is facilitated. In one embodiment, the bot-agent facilitates transmission of content information to the users engaged in the IM session for further use and sharing.

In one embodiment, the bot-agent is used as a mediator or a participant in user conferences, offering services to multiple users concurrently. When a bot is an additional participant, the bot is not really part of the conversation, but just enables users to make decisions together, to share results of searches, and to receive faster results. For example, as shown in FIG. 7, user A 71 might be engaged in a discussion with user B 72. Both users A and B can connect to a bot-agent 75 and use the bot-agent 75 as a support tool, such as, for example, to ask the bot to record their conversation, or to publish the conversation to a server, or to tell them calendar information. In an alternate embodiment, user A 71 may command the bot-agent 75 to route messages to the user B 72 and vice-versa. Thus, the bot-agent 75 becomes a listener to the discussion and may offer services to both users A and B to support them in the IM session, such as, for example, to translate their messages, or to offer users the results of searches or queries to external services.

Referring back to FIG. 11, if the session is not established between multiple users, then at processing block 206, a request to retrieve content information is transmitted to the bot-agent. In one embodiment, the user transmits a request to the bot-agent to locate and retrieve content information. At processing block 207, the content information is received from the bot-agent. In one embodiment, the bot-agent retrieves the requested content information and transmits the content information to the user.

In one embodiment, a user accesses the bot-agent via the direct IM session and transmits a message to the bot to request retrieval of content information, such as, for example, a list of movies playing in a certain area code. The bot-agent searches the database for the requested content information, retrieves the requested content information, and transmits the content information to the user via the IM session. Subsequently, the IM session between the user and the bot-agent is terminated.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A system comprising:
a client authoring application which runs on at least one user's client device, said client authoring application
presenting a service interface area displayed on each user's device screen, said service interface area facilitating user selection of content information transmitted from a server supporting at least one external application; and
presenting a user authoring interface area displayed on each user's device screen, said authoring interface area facilitating user insertion of said content information into said authoring interface area; and
means for accessing at least one application agents, each application agent being associated to an external application;
wherein when any of said at least one application agents is activated, said external application represented by said activated application agent runs on top of the client authoring application such that said user can instantly use said external application represented by said activated application agent.

2. The system of claim 1, wherein said external application is either a local application in the user's device or a third party service on a global network.

3. The system of claim 2, wherein said third party service on said global network is any of:
an instant translation service;
a speech synthesis service;
an automatic publishing service;
a picture sharing service;
a map sharing service;
a quote service; and
a Web search engine.

4. The system of claim 1, wherein said client authoring application is a web logging authoring application.

5. The system of claim 1, wherein said client authoring application is an electronic mail authoring application.

6. The system of claim 1, wherein said service interface area facilitates user selection of said content information with a conventional mouse click command.

7. The system of claim 1, wherein said authoring interface area facilitates user insertion of said content information with a conventional mouse click-and-drag command.

8. The system of claim 1, wherein said content information is displayed within said service interface area as a plurality of icons.

9. A system comprising:
a client communication application which runs on at least one user's client device, said client communication application establishing a communication session among users; and
means for accessing at least one application agents, each application agent being associated to an external application;
wherein when any of said at least one application agents is activated, said external application represented by said activated application agent runs on top of said client communication application such that said user can instantly use said external application represented by said activated application agent and receive content information from said external application for use in said communication session.

10. The system of claim 9, wherein said external application is either a local application in the user's device or a third party service on a global network.

11. The system of claim 10, wherein said third party service on said global network is any of:
an instant translation service;
a speech synthesis service;
an automatic publishing service;
a picture sharing service;
a map sharing service;
a quote service; and
a Web search engine.

12. The system of claim 9, wherein said client communication application is an instant messaging client application and said communication session is an instant messaging session.

13. The system of claim 9, wherein said communication session is established among multiple users and said users further request participation of said activated application agent into said communication session.

14. The system of claim 13, wherein said activated application agent further participates in said communication session and facilitates transmission of said content information to said users for further use and sharing.

15. The system of claim 9, wherein said user establishes a direct communication session with said activated application agent and further requests retrieval of content information from said external application, and wherein said activated application agent retrieves said requested content information and transmits said content information to said user via said direct communication session.

16. A method comprising:
accessing at least one application agents, each application agent being associated to an external application;
activating an application agent of said at least one application agents;
presenting a service interface area for facilitating user selection of content information transmitted from a server supporting said external application; and
presenting a user authoring interface area for facilitating user insertion of said content information into said authoring interface area.

17. The method according to claim 16, wherein when said application agent is activated, said external application represented by said activated application agent runs on top of a client authoring application presenting said service interface area and said user authoring interface area, such that said user can instantly use said external application represented by said activated application agent.

18. A method comprising:
accessing at least one application agents, each application agent being associated to an external application;
activating an application agent of said at least one application agents; and
establishing a communication session among users;
receiving content information from said external application via said activated application agent for use in said communication session.

19. The method of claim 18, wherein said client communication application is an instant messaging client application and said communication session is an instant messaging session.

20. The method of claim 19, further comprising:
establishing a direct communication session with said activated application agent; and
requesting retrieval of said content information from said external application via said activated application agent.

21. A computer readable medium containing executable instructions, which, when executed in a processing system, cause said processing system to perform a method comprising:
accessing at least one application agents, each application agent being associated to an external application;
activating an application agent of said at least one application agents;
presenting a service interface area for facilitating user selection of content information transmitted from a server supporting said external application; and
presenting a user authoring interface area for facilitating user insertion of said content information into said authoring interface area.

22. A computer readable medium containing executable instructions, which, when executed in a processing system, cause said processing system to perform a method comprising:
accessing at least one application agents, each application agent being associated to an external application;
activating an application agent of said at least one application agents; and
establishing a communication session among users;
receiving content information from said external application via said activated application agent for use in said communication session.
